(19) United States
(12) Patent Application Publication
(10) Pub. No.: US 2007/0267243 A1
(43) Pub. Date: Nov. 22, 2007

(54) MULTI-PURPOSE KEY SWITCH FOR LIGHTWEIGHT UTILITY VEHICLE

(75) Inventors: Oliver A. Bell,, Aiken, SC (US); Aric Singletary, Hephzibah, GA (US); Michael J. Hebert, Evans, GA (US); Warren Clark, Evans, GA (US); Gregory Schlachter, Trenton, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,257

(22) Filed: May 19, 2006

(51) Int. Cl. B60K 17/00

(52) U.S. Cl. 180/336

(57) ABSTRACT

A vehicle operation control switch for a light-weight utility vehicle is provided. The vehicle operation control switch includes an ‘Off’ setting or position. When the switch is placed in the ‘Off’ position, the switch disables a vehicle prime mover that generates motive forces utilized to propel the vehicle when enabled. The switch additionally includes a ‘Forward’ setting or position, whereby when the switch is moved to the ‘Forward’ setting, the vehicle prime mover is enabled and the vehicle is configured in a ‘Forward’ movement operational mode. Furthermore, the switch includes a ‘Reverse’ setting for enabling the vehicle prime mover and placing the vehicle in a ‘Reverse’ movement operational mode.

### FIELD

The present disclosure relates to a key switch for a vehicle that provides a variety of functions.

### BACKGROUND

Known drive controls for light-weight utility vehicles, such as maintenance vehicles, shuttle vehicles and golf cars, generally include a separate, independent rocker switch movable between a ‘Forward’ position, a ‘Reverse’ position and a ‘Neutral’ position. Such drive control rocker switches typically control the drive operation of the vehicle by either controlling the function of a mechanical gear box, e.g., a transmission, or electronically controlling the operation of an electric prime mover, e.g., an electric motor, of the vehicle. Generally, to place the vehicle in a ‘Forward’ drive operational mode, the rocker switch is moved to the ‘Forward’ position. Similarly, to place the vehicle in a ‘Reverse’ drive operational mode, the rocker switch is moved to the ‘Reverse’ position, and to place the vehicle in a ‘Neutral’ drive operational mode, the rocker switch is moved to the ‘Neutral’ position. Such drive control rocker switches usually require connection to a plurality of small electrical and/or mechanical components during assembly of the vehicle.

Typically light-weight utility vehicles additionally have a key controlled ‘On/Off’ switch that is separate and independent from the drive control rocker switch. Such key controlled ‘On/Off’ switch usually also requires connection to a plurality of small electrical and/or mechanical components during assembly of the vehicle that are separate from the drive control components. Thus, to operate the vehicle, an operator of the vehicle must turn the key controlled ‘On/Off’ switch to the ‘On’ position and then move the drive control rocker switch to the desired position, i.e., the ‘Forward’, ‘Reverse’ or ‘Neutral’ position.

### SUMMARY

In accordance with various embodiments of the present disclosure, a vehicle operation control switch for a light-weight utility vehicle is provided. The vehicle operation control switch includes an ‘Off’ setting or position. When the switch is placed in the ‘Off’ position, the switch disables a vehicle prime mover that generates motive forces utilized to propel the vehicle when enabled. The switch additionally includes a ‘Forward’ setting or position, whereby when the switch is moved to the ‘Forward’ setting, the vehicle prime mover is enabled and the vehicle is configured in a ‘Forward’ movement operational mode. Furthermore, the switch includes a ‘Reverse’ setting for enabling the vehicle prime mover and placing the vehicle in a ‘Reverse’ movement operational mode.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of a light-weight utility vehicle including a vehicle operation control switch, in accordance with various embodiments of the present disclosure;

FIG. 2 is an exemplary isometric view of the vehicle operation control switch shown in FIG. 1, in accordance with various embodiments of the present disclosure;

FIG. 3 is an exemplary isometric view of the vehicle operation control switch shown in FIG. 1, in accordance with various other embodiments of the present disclosure;

FIG. 4 is a side view of the control switch shown in FIG. 1 comprising a signal control device, in accordance with various embodiments of the present disclosure; and

FIG. 5 is a table illustrating the various signals that are received and output by the operation control switch shown in FIG. 1, in accordance with various other embodiments of the present disclosure.

### DETAILED DESCRIPTION

The following description of various embodiments is merely exemplary in nature and is in no way intended to limit the present teachings, application, or uses.

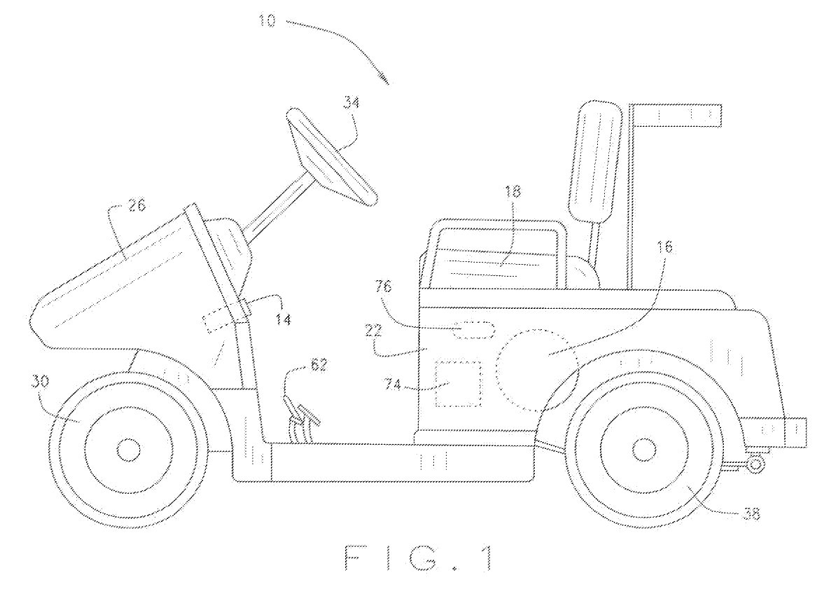

FIG. 1 illustrates a light-weight utility vehicle 10, such as a small cargo/maintenance vehicle, a shuttle vehicle or a golf car, that comprises a vehicle operation control switch 14. The control switch 14 is utilized to selectively disable a vehicle prime mover 16 in an ‘Off’ operational mode, or selectively enable the prime mover 16 while substantially simultaneously selecting a ‘Forward’ movement operational mode or a ‘Reverse’ movement operational mode of the vehicle 10. In various embodiments, the switch 14 can additionally be utilized to selectively enable the vehicle prime mover 16 while substantially simultaneously selecting a ‘Neutral’ operational mode of the vehicle 10. The vehicle 10 also generally includes a seat assembly 18 mounted to a rear body section 22, a front body section 26, a pair of front wheels 30 controlled by a steering wheel 34 to steer the vehicle 10. Additionally, the vehicle 10 generally comprises a pair of rear wheels 38. At least one of the rear wheels 38 utilizes rotational forces generated by the vehicle prime mover 16, e.g., an engine or electric motor, to drive the wheel 38 and propel the vehicle 10.

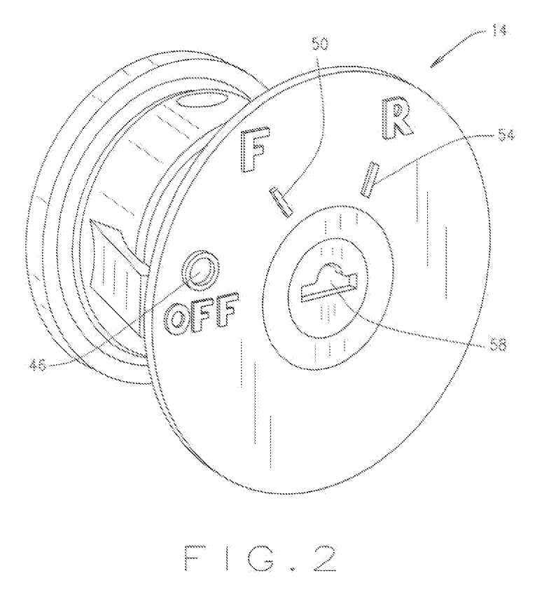

Referring now to FIG. 2, in accordance with various embodiments of the present disclosure, the vehicle operation control switch 14 comprises an ‘Off’ setting or position 46, a ‘Forward’ setting or position 50 and a ‘Reverse’ setting or position 54. In various embodiments, the switch 14 comprises a rotary type switch including a key receptacle 58 that receives a key (not shown) used to move the switch between the ‘Off’, ‘Forward’ and ‘Reverse’ positions. However, in various other embodiments, the switch 14 can be any switch suitable to transition the vehicle 14 between the ‘Off’, ‘Forward’, ‘Reverse’ and/or ‘Neutral’ operational modes, as described herein, e.g., a slide type, a push button type or rocker type switch.

Generally, when the control switch 14 is placed in the ‘Off’ position 46, the switch 14 disables the vehicle prime mover 16 such that the prime mover 16 can not be utilized to generate motive forces for propelling the vehicle 10. When the switch 14 is moved to the ‘Forward’ setting 50, the switch 14 enables the prime mover 16 to provide motive forces used to propel the vehicle 10. Substantially simultaneously, the switch 14 enables the ‘Forward’ movement operational mode of the vehicle 10 whereby forces generated by the prime mover 16 will move the vehicle 10 in the forward direction when a vehicle accelerator 62 (exemplarily shown in FIG. 1) is activated, e.g., depressed. Similarly, when the switch 14 is moved to the ‘Reverse’ position 54, the switch 14 enables the prime mover 16 to provide motive forces used to propel the vehicle 10 and substantially simultaneously enables the ‘Reverse’ movement operational mode of the vehicle 10. When in the ‘Reverse’ movement operational mode forces generated by the prime mover 16 will move the vehicle 10 in the reverse direction when a vehicle accelerator 62 is activated.

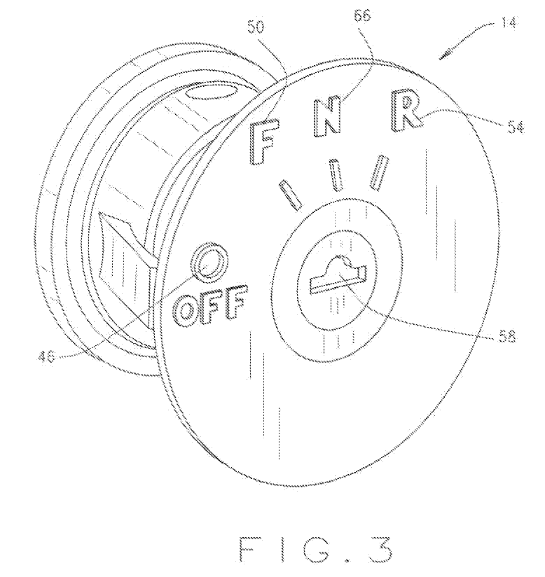

Referring to FIGS. 2 and 3, in various embodiments, the switch 14 additionally comprises a ‘Neutral’ setting or position 66. When the switch 14 is moved to the ‘Neutral’ position 66, the switch 14 enables the prime mover 16 to generate motive forces used to propel the vehicle 10 and substantially simultaneously enables the ‘Neutral’ operational mode of the vehicle 10. When in the ‘Neutral’ operational mode, if the accelerator 62 is activated, forces generated by the prime mover 16 will not be imparted on the vehicle 10 to move the vehicle 10 in either the forward or the reverse directions. That is, when the vehicle 10 is in the ‘Neutral’ operational mode the prime mover 16 is enabled, but can not be utilized to propel the vehicle 10.

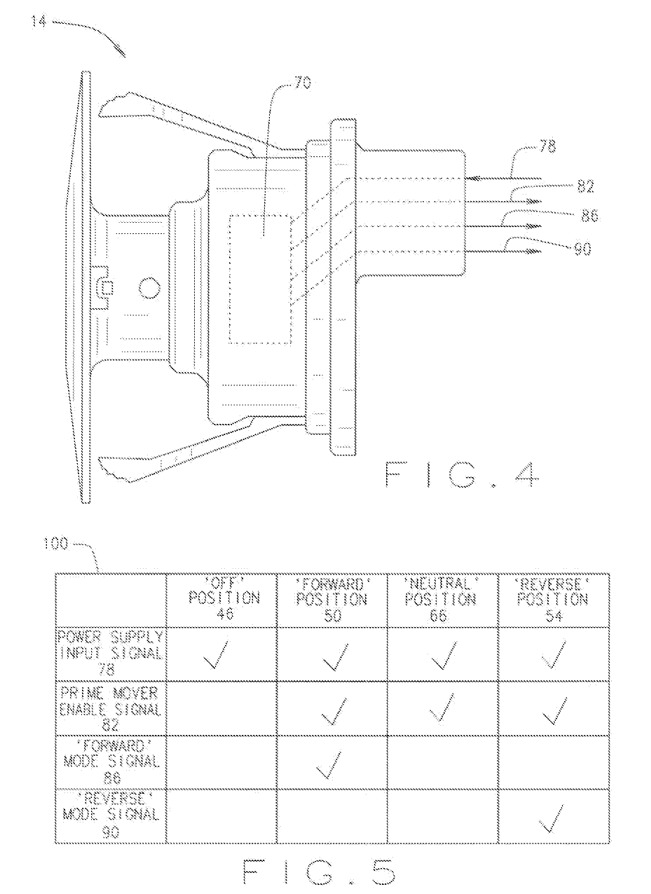

Referring now to FIGS. 2, 3 and 4, in various embodiments, the switch 14 comprises a signal control device 70 that can be communicatively connected to a power source 74, e.g., one or more batteries. The signal control device 70 can additionally be communicatively connected to a vehicle drive operations controller 76 (shown in FIG. 1) that controls operation of the prime mover 16 and the distribution of forces generated by the prime mover 16 to propel the vehicle 10. The vehicle drive operations controller 76 can be an independent, stand-alone controller or a multipurpose or multifunction controller used to control various other operations of the vehicle 10, e.g., a comprehensive vehicle system controller. The signal control device 70 is configured to receive a power input signal 78 from the power source 74. The signal control device 70 is further configured output to the drive operations controller 76 a prime mover enable signal 82 and substantially simultaneously one of a ‘Forward’ operational mode signal 86 and a ‘Reverse’ operational mode signal 90, depending on the switch setting or position 50 or 54. When the switch 14 is placed in the ‘Off’ position 46, the signal control device 70 is configured to output no signal, particularly to discontinue output of the prime mover enable signal 82. Additionally, in various embodiments, as described herein, the signal control device 70 is configured to output only the prime mover enable signal 82 when the switch 14 is placed in the ‘Neutral’ setting.

In various embodiments, the signal control device 70 comprises a mechanical switching device that receives the power input signal 78. The switching device then distributes the power input signal 78, depending on the switch setting 46, 50, 54 or 66, to output the respective prime mover enable signal 82, the ‘Forward’ operational mode signal 86 and the ‘Reverse’ operational mode signal 90 to the drive operations controller 76. For example, the signal control device 70 can be an interconnected multi-ring contact device. In various other embodiments, the signal control device 70 can be an electronic circuit device, such as a microprocessor. In which case, signal control device 70 receives the power input signal 78 and, based on the switch setting 46, 50, 54 or 66, outputs logic signals 90 to the drive operations controller 76. The logic signals comprising the respective prime mover enable signal 82, the ‘Forward’ operational mode signal 86 and the ‘Reverse’ operational mode signal 90.

Referring now to FIGS. 2, 3, 4 and 5, FIG. 5 illustrates a table 100 indicating the various signals 78, 82, 86 and/or 90 that are received and output by the signal control device 70 based on the switch position or setting 46, 50, 54 and/or 66. As indicated in table 100, when the switch 14 is placed in the ‘Off’ position 46, the signal control device 70 receives the power supply input signal 78, but does not output any corresponding signal to the drive operations controller 76. Thus, the prime mover 16 is disabled and the vehicle 10 is in a non-operational state. When the switch 14 is moved to the ‘Forward’ setting 50, the signal control device 70 continues to receive the power supply input signal 78 and outputs the prime mover enable signal 82 to enable the prime mover 16. Additionally, when the switch 14 is placed in ‘Forward’ position 50, the signal control device 70 outputs the ‘Forward’ operational mode signal 86 substantially simultaneously with the prime mover enable signal 82. Accordingly, when the switch 14 is placed in ‘Forward’ position 50, the vehicle 10 will be propelled in the forward direction when the accelerator 62 is activated.

When the switch 14 is moved to the ‘Reverse’ setting 54, the signal control device 70 continues to receive the power supply input signal 78 and continues to output the prime mover enable signal 82 to enable the prime mover 16. Additionally, when the switch 14 is placed in ‘Reverse’ position 54, the signal control device 70 outputs the ‘Reverse’ operational mode signal 90 substantially simultaneously with the prime mover enable signal 82. Accordingly, when the switch 14 is placed in ‘Reverse’ position 54, the vehicle 10 will be propelled in the reverse direction when the accelerator 62 is activated. Moreover, when the switch 14 is moved from the ‘Forward’ position 50 to the ‘Reverse’ position 54 or from the ‘Reverse’ position 54 to the ‘Forward’ position 50, the signal control device 70 continuously outputs the prime mover enable signal 82. That is, the switch 14 can be transitioned between the ‘Forward’ and ‘Reverse’ positions 50 and 54 without disabling the prime mover 16.

Furthermore, in accordance with various embodiments described herein, when the switch 14 is placed in the ‘Neutral’ position 66, the signal control device 70 continues to receive the power supply input signal 78 and continues to output the prime mover enable signal 82 to enable the prime mover 16. However, when the switch 14 is placed in ‘Neutral’ position 66, the signal control device 70 does not output a ‘Forward’ or ‘Reverse’ operational mode signal 86 or 90. Accordingly, when the switch 14 is placed in ‘Neutral’ position 66, the primer mover 16 is enabled but the vehicle 10 will be placed in a ‘Neutral’ operational mode and will not be propelled in either the forward or reverse direction if the accelerator 62 is activated. Moreover, when the switch 14 can be moved or transitioned between the ‘Forward’, ‘Neutral’ and ‘Reverse’ positions 50, 66 and 54 the signal control device 70 continuously outputs the prime mover enable signal 82. That is, the switch 14 can be transitioned between the ‘Forward’, ‘Neutral’ and ‘Reverse’ positions 50, 66 and 54 without disabling the prime mover 16.

Referring now to FIGS. 2 and 3, it should be understood that in the various embodiments wherein the switch 14 is a rotary switch, the orientation and sequence or order of the ‘Off’, ‘Forward’, ‘Neutral’ and ‘Reverse’ can vary from that shown in FIGS. 2 and 3, without departing from the scope of the present disclosure.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A vehicle operation control switch for a light-weight utility vehicle, said switch comprising:
an ‘Off’ setting for disabling a vehicle prime mover;
a ‘Forward’ setting for enabling the vehicle prime mover and placing the vehicle in a ‘Forward’ movement mode; and
a ‘Reverse’ setting for enabling the vehicle prime mover and placing the vehicle in a ‘Reverse’ movement mode.

2. The switch of claim 1, wherein the switch comprises a key receptacle for receiving a key utilized to move the switch between the ‘Off’, ‘Forward’ and ‘Reverse’ settings.

3. The switch of claim 1, wherein the switch is configured to transition between the ‘Forward’ and the ‘Reverse’ settings without disabling the vehicle prime mover.

4. The switch of claim 1, wherein the switch further comprises a signal control device for receiving a power input signal and outputting a prime mover enable signal, a ‘Forward’ operational mode signal and a ‘Reverse’ operational mode signal.

5. The switch of claim 4, wherein the signal control device is configured to output the prime mover enable signal and the ‘Forward’ operational mode signal when the switch is placed in the ‘Forward’ setting.

6. The switch of claim 4, wherein the signal control device is configured to output the prime mover enable signal and the ‘Reverse’ operational mode signal when the switch is placed in the ‘Reverse’ setting.

7. The switch of claim 4, wherein the control device comprises one of a mechanical switching device and a switching circuit board.

8. The switch of claim 1, wherein the switch further comprises a ‘Neutral’ setting for enabling the vehicle prime mover and placing the vehicle in a ‘Neutral’ mode.

9. The switch of claim 8, wherein the switch comprises a key receptacle for receiving a key utilized to move the switch between the ‘Off’, ‘Forward’, ‘Neutral’ and ‘Reverse’ settings.

10. The switch of claim 8, wherein the switch is configured to transition between the ‘Forward’, the ‘Neutral’ and the ‘Reverse’ settings without disabling the vehicle prime mover.

11. The switch of claim 8, wherein the switch further comprises a signal control device for receiving a power input signal and outputting a prime mover enable signal, a ‘Forward’ operational mode signal and a ‘Reverse’ operational mode signal.

12. The switch of claim 11, wherein the signal control device is configured to output the prime mover enable signal and the ‘Forward’ operational mode signal when the switch is placed in the ‘Forward’ setting.

13. The switch of claim 11, wherein the signal control device is configured to output the prime mover enable signal and the ‘Reverse’ operational mode signal when the switch is placed in the ‘Reverse’ setting.

14. The switch of claim 11, wherein the signal control device is configured to output the prime mover enable signal when the switch is placed in the ‘Neutral’ setting.

15. A light-weight utility vehicle comprising a vehicle operation control switch, said switch comprising:
an ‘Off’ position for disabling a vehicle prime mover;
a ‘Forward’ position for enabling the vehicle prime mover and placing the vehicle in a ‘Forward’ movement mode; and
a ‘Reverse’ position for enabling the vehicle prime mover and placing the vehicle in a ‘Reverse’ movement mode.

16. The vehicle of claim 15, wherein the switch comprises a key receptacle for receiving a key utilized to move the switch between the ‘Off’, ‘Forward’ and ‘Reverse’ positions.

17. The vehicle of claim 15, wherein the switch is configured to transition between the ‘Forward’ and the ‘Reverse’ positions without disabling the vehicle prime mover.

18. The vehicle of claim 15, wherein the switch is configured to output a prime mover enable signal and a ‘Forward’ operational mode signal when the switch is placed in the ‘Forward’ position.

19. The vehicle of claim 18, wherein the switch is configured to output the prime mover enable signal and a ‘Reverse’ operational mode signal when the switch is placed in the ‘Reverse’ position.

20. The vehicle of claim 15, wherein the switch further comprises a ‘Neutral’ position for enabling the vehicle prime mover and placing the vehicle in a ‘Neutral’ operational mode.

21. The vehicle of claim 20, wherein the switch comprises a key receptacle for receiving a key utilized to move the switch between the ‘Off’, ‘Forward’, ‘Neutral’ and ‘Reverse’ positions.

22. The vehicle of claim 20, wherein the switch is configured to transition between the ‘Forward’, the ‘Neutral’ and the ‘Reverse’ positions without disabling the vehicle prime mover.

23. The vehicle of claim 20, wherein the switch is configured to output a prime mover enable signal when the switch is placed in the ‘Neutral’ position.

24. A method for controlling an operational mode of a light-weight utility vehicle, said method comprising:
substantially simultaneously outputting a prime mover enable signal and a ‘Forward’ operational mode signal from an operational control switch when the switch is placed in a ‘Forward’ position, thereby enabling the vehicle prime mover and placing the vehicle in a ‘Forward’ operational mode;
substantially simultaneously outputting the prime mover enable signal and a ‘Reverse’ operational mode signal from the switch when the switch is placed in a ‘Reverse’ position, thereby enabling the vehicle prime mover and placing the vehicle in a ‘Reverse’ operational mode; and
ceasing to output the prime mover enable signal when the switch is placed in an ‘Off’ position, thereby disabling the vehicle primer mover.

25. The method of claim 24, wherein the method further comprises inserting a key into a key receptacle of the switch to move the switch between the ‘Off’, ‘Forward’ and ‘Reverse’ positions.

26. The method of claim 24, wherein the method further comprises transitioning the switch between the ‘Forward’ and the ‘Reverse’ positions without ceasing to output the prime mover enable signal.

27. The method of claim 24, wherein the method further comprises outputting the prime mover enable signal when the switch is placed in a ‘Neutral’ position for enabling the vehicle prime mover and placing the vehicle in a ‘Neutral’ operational mode.

28. The method of claim 27, wherein the method further comprises inserting a key into a key receptacle of the switch to move the switch between the ‘Off’, ‘Forward’, ‘Neutral’ and ‘Reverse’ positions.

29. The method of claim 27, wherein the method further comprises transitioning the switch between the ‘Forward’, the ‘Neutral’ and the ‘Reverse’ positions without ceasing to output the prime mover enable signal.
